(19) United States
(12) Patent Application Publication
(10) Pub. No.: US 2004/0081042 A1
(43) Pub. Date: Apr. 29, 2004

(54) Optical disc drive

(75) Inventors: Kenji Kondo, Osaka (JP); Katsuya Watanabe, Nara-shi (JP); Yuichi Kuze, Osaka (JP); Eiji Ueda, Yawata-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/691,381

(22) Filed: Oct. 22, 2003

(30) Foreign Application Priority Data
Oct. 23, 2002 (JP) 2002-308231

(51) Int. Cl. G11B 7/095

(52) U.S. Cl. 369/44.35

(57) ABSTRACT

An optical disc drive includes an optical system, a photodetector, a filter, a phase difference detecting section, a signal generating section, and a control section. The optical system focuses a light beam on an optical disc loaded. The photodetector includes areas to receive the light beam reflected from the disc and generates read signals representing quantities of light received. The filter receives the read signals and outputs processed signals with a frequency component of the read signals attenuated according to mark lengths. The phase difference detecting section detects a phase difference between the processed signals. The signal generating section generates a tracking error signal, representing a positional relationship between the focal point and a target track, based on the phase difference. The control section generates a control signal based on the tracking error signal such that the focal point is controlled across the tracks on the disc.

### BACKGROUND OF THE INVENTION

1. Field of the Invention

The present invention relates to a technique of reading and/or writing data from/on data storage media of various types including read-only ones and recordable (or rewritable) ones. More particularly, the present invention relates to an optical disc drive for use to control the spot of a light beam (e.g., a laser beam), which has been focused on an optical disc, such that the beam spot can accurately scan the target tracks on the disc in reading and/or writing data from/on the disc.

2. Description of the Related Art

Optical discs such as DVDs are used more and more extensively as storage media to store digital information thereon. As the amount of digital information to store on such discs has been escalating recently, recording density of optical discs must be further increased to cope with such demands.

Each and every optical disc includes at least one track. Specifically, on a read-only optical disc, for example, information is stored as an alternate arrangement of pits and spaces along the tracks. On a recordable (or rewritable) optical disc on the other hand, information is stored as an alternate arrangement of recording marks and spaces along the tracks. In this case, the “pits” are defined as embossed concave or convex portions, which have been deformed perpendicularly to the mirror surface of the data storage layer. Meanwhile, the “recording marks” are portions in which the phase of the data storage layer has changed locally due to the exposure to a laser pulse. The “spaces” refer to the remaining portions of the tracks on which no pits or recording marks are present. The light beam is reflected from a pit and a space at mutually different reflectances, and also returns from a recording mark and a space at two different reflectances. However, those pits and recording marks on the tracks, which actually have two different reflectances strictly speaking, will be collectively referred to herein as “marks” for the sake of simplicity.

An optical disc drive, which reads and/or writes data from/on an optical disc, is recently required to further increase its reliability. The optical disc drive reads those marks by performing a tracking control operation such that the beam spot follows the target tracks on the disc.

A method of performing a tracking control operation by a phase difference tracking error (TE) signal detecting technique is known as one of conventional tracking control methods for optical disc drives. For example, in a phase difference TE signal detecting technique disclosed in Japanese Laid-Open Publication No. 10-149550 (see page 5 and FIG. 11), the light that has been reflected from an optical disc is received at a number of photodetectors, thereby generating a TE signal based on variations in intensity patterns on the photodetectors. The TE signal represents how much a beam spot has shifted from the center of a target track (or the center of a target mark). Then, in accordance with the TE signal generated, the optical disc drive carries out a tracking control operation. In the phase difference TE signal detecting method, the TE signal is generated based on the variations in the intensity patterns with time, not the variation in the intensity of the reflected light itself. Thus, its responsivity does not depend on the output power of the light beam. In addition, since the tracking error can be detected by just one beam, a low-output light source may be used. With these advantages, the phase difference TE signal detecting method has often been used in CD-ROM drives, DVD-ROM drives and various other optical disc drives.

Hereinafter, a conventional optical disc drive that adopts the phase difference TE signal detecting method will be described more specifically with reference to FIG. 10. FIG. 10 shows a configuration for the conventional optical disc drive 500, which is disclosed in Japanese Laid-Open Publication No. 2000-315327 (see pages 9 to 10 and FIG. 9), for example.

The optical disc drive 500 generates a TE signal as follows. First, a light source 101 emits a linearly polarized light beam, which is collimated by a collimator lens 102 into a parallel light beam. Then, a polarization beam splitter 103 reflects the light beam toward a quarter wavelength plate 104. In response, the quarter wavelength plate 104 transforms the linearly polarized light beam into a circularly polarized light beam, which is then converged by an objective lens 105 onto an optical disc 20.

Next, the light beam is reflected from the optical disc 20, transmitted through the polarization beam splitter 103 and a convergent lens 107, and then incident onto the four divided areas of a photodetector 108. On receiving four electric signals, representing the respective quantities of light received at the four divided areas, from the photodetector 108, pre-amplifiers 109a, 109b, 109a and 109d convert these electric signals into voltage signals. Next, an adder 110a adds together the output signals of the pre-amplifiers 109a and 109c, thereby outputting a sum signal A+C. Meanwhile, an adder 110b adds together the output signals of the pre-amplifiers 109b and 109d, thereby outputting a sum signal B+D. Thereafter, digitizers 111a and 111b convert the sum signals A+C and B+D into digital signals a1 and a2, respectively, by reference to a predetermined slice level. FIG. 11 shows the waveforms of the digital versions a1 and a2 of the sum signals A+C and B+D.

Subsequently, a phase comparator 112 compares the phase of the leading or trailing edges of the digital signal a1 with that of associated edges of the digital signal a2, thereby outputting a phase lead signal b1, of which the pulse width represents the magnitude of the phase lead, and a phase lag signal b2, of which the pulse width represents the magnitude of the phase lag. FIG. 11 also shows the waveforms of the phase lead signal b1 and phase lag signal b2. Thereafter, low pass filters (LPFs) 113a and 113b smooth out the phase lead and phase lag signals b1 and b2, thereby converting these signals b1 and b2 into voltage signals of which the levels represent their respective pulse widths. Finally, the output voltage signals of the LPFs 113a and 113b are subtracted from one another by a subtractor 114, thereby generating a phase difference TE signal ΔTE representing the shift of the beam spot from the target track. In this manner, the optical disc drive 500 generates the phase difference TE signal.

A control circuit 117 includes a phase compensator and a low-frequency compensator, which may be implemented as digital filters of a digital signal processor (DSP), for example, and processes the received phase difference TE signal ΔTE by using those circuits, thereby generating a tracking drive signal. Next, a driver 50 amplifies the tracking drive signal and then outputs the amplified signal to a tracking actuator 115. In response, the tracking actuator 115 moves the objective lens 105 in the radial direction of the optical disc 20, thereby allowing the beam spot to scan the target tracks on the optical disc 20.

However, when the density of optical discs is further increased in the near future, the conventional optical disc drive will no longer be able to produce a TE signal accurately enough to carry out the tracking control operation just as intended. The reason is as follows. Specifically, as the density of optical discs is further increased, the relative size of marks will decrease with respect to the beam spot size. Then, the variation in the intensity of the reflected light beam before and after the beam spot passes a given mark will have a decreased amplitude, too. In a worst case scenario, the amplitude of the intensity variation to be detected may be almost no different from that of noise. A signal representing such small amplitude is too bad in quality to produce a TE signal accurately enough.

Also, compared with a signal with large amplitude, such a signal with small amplitude is much more easily affected by a small difference in slice level while being digitized by a digitizer. In that case, the resultant TE signal should contain errors. Generally speaking, a digitizer is an electric circuit, of which the components naturally exhibit some variations in their electrical characteristics. For that reason, it is normally difficult to match the slice level of a given digitizer to that of another digitizer. That is to say, it is not an unthinkable situation that there is a slight difference between the two slice levels, which will make the resultant TE signal erroneous. Naturally, it is possible to amplify such a signal with small amplitude. However, this is not a preferred technique, either, because unwanted noise components will also be amplified in that case.

Hereinafter, it will be described with reference to FIG. 12 how such a small difference in slice level affects the resultant TE signal. FIG. 12 shows the waveforms of the output signals of the respective circuits in a situation where there is no difference Δv between the slice levels and a situation where there is a small difference Δv between the slice levels. Specifically, portion (a) of FIG. 12 shows the waveforms of the output signals A+C and B+D of the adders 110a and 110b in a situation where the beam spot has a certain shift with respect to the target track (i.e., in an off-track state). If there is no difference between the slice levels of the digitizers 111a and 111b, then the digitizers 111a and 111b will have the same slice level S1. On the other hand, if there is a small difference Δv between them, then the digitizers 111a and 111b will have their respective slice levels S1 and S2. Since the beam spot is in the off-track state, there is a certain time lag between the waveforms of the two sum signals A+C and B+D.

Portion (b) of FIG. 12 shows the waveforms of the output signals a1, a2, b1 and b2 in a situation where there is no difference between the slice levels. As can be seen from this portion (b), the phase lead signal b1 indicates that there is a certain phase lead between the signals A+C and B+D, and the phase lag signal b2 indicates that there is no phase lag between the signals A+C and B+D.

On the other hand, portion (c) of FIG. 12 shows the waveforms of the output signals a1, a2, b1 and b2 in a situation where there is the small difference Δv between the slice levels. As can be seen when these portions (b) and (c) of FIG. 12 are compared with each other, the waveform of the output signal b1 or b2 in the portion (b) is different from that of the output signal b1 or b2 in the portion (c) due to the small difference Δv in slice level. Such a difference in the waveform of the output signal b1 or b2 represents a detection error. Particularly when the read signals A+C and B+D have small amplitudes just after the beam spot has passed a shortest mark, the detection error is relatively significant. Otherwise, the detection error is not so outstanding though. In a high-density optical disc, the shortest mark length is even shorter than the conventional shortest mark length. Accordingly, the amplitude of a signal resulting from that shortest mark is very small as shown portion (a) of FIG. 12. As a result, in reading such a high-density optical disc, the detection error caused by the slight difference Δv between the slice levels should be non-negligible and significant.

Thus, in the conventional optical disc drive, portions of the read signal A+C or B+D with small amplitudes have brought about the increase in the magnitude of detection errors of the TE signal and decrease in the quality of the TE signal.

### SUMMARY OF THE INVENTION

In order to overcome the problems described above, an object of the present invention is to provide an optical disc drive that can generate a TE signal accurately enough to carry out a tracking control operation just as intended even if the marks to be recorded on a storage medium have a reduced size.

An optical disc drive according to a preferred embodiment of the present invention is preferably loaded with an optical disc that includes tracks on which a plurality of marks are formed. The optical disc drive preferably includes an optical system, a photodetector, a filter, a phase difference detecting section, a signal generating section, and a control section. The optical system preferably focuses a light beam on the optical disc loaded. The photodetector preferably includes multiple areas to receive the light beam that has been reflected from the optical disc and preferably generates multiple read signals representing quantities of light received at the areas. The filter preferably receives the read signals and preferably outputs multiple processed signals with one of frequency components of the read signals attenuated. The frequency component to be attenuated is preferably determined by the lengths of the marks. The phase difference detecting section preferably detects a phase difference between the processed signals. The signal generating section preferably generates a tracking error signal, representing a positional relationship between a focal point of the light beam on the optical disc and a target one of the tracks, based on the phase difference. The control section preferably generates a control signal based on the tracking error signal. In accordance with the control signal, the optical disc drive preferably controls the focal point of the light beam across the tracks on the optical disc.

In one preferred embodiment of the present invention, the optical system preferably includes a light source to emit the light beam, a lens to focus the light beam on the optical disc, and an actuator to adjust a position of the lens. In response to the control signal, the optical disc drive preferably drives the actuator to adjust the position of the lens such that the focal point of the light beam is located on the center of the target track.

In this particular preferred embodiment, the filter preferably removes the frequency component.

In an alternative preferred embodiment, the filter may remove a frequency component having a particular frequency that is determined by the minimum length of the marks.

In that case, the filter preferably removes frequency components of which the frequencies are equal to or higher than the particular frequency.

More particularly, the filter preferably removes a frequency component of a frequency that corresponds to a mark of second shortest length.

In yet another preferred embodiment, the optical disc drive may determine the frequency by a linear velocity of the track and the length of the mark at the focal point of the light beam. Then, the filter preferably attenuates the frequency component of the determined frequency.

A tracking control method according to another preferred embodiment of the present invention preferably includes the steps of: focusing a light beam on an optical disc that includes tracks on which a plurality of marks are formed; receiving the light beam, reflected from the optical disc, at multiple areas; generating multiple read signals representing quantities of light received at the areas; and receiving the read signals and outputting multiple processed signals with one of frequency components of the read signals attenuated. The frequency component to be attenuated is preferably determined by the lengths of the marks. The method preferably further includes the steps of: detecting a phase difference between the processed signals; generating a tracking error signal, representing a positional relationship between a focal point of the light beam on the optical disc and a target one of the tracks, based on the phase difference; generating a control signal based on the tracking error signal: and controlling the focal point of the light beam across the tracks on the optical disc in accordance with the control signal.

A computer program product according to another preferred embodiment of the present invention is used with an optical disc drive for tracking control purposes. The optical disc is loaded with an optical disc that includes tracks on which a plurality of marks are formed. The computer program is preferably defined to make the optical disc drive execute the steps of: focusing a light beam on the optical disc loaded; receiving the light beam, reflected from the optical disc, at multiple areas; generating multiple read signals representing quantities of light received at the areas; and receiving the read signals and outputting multiple processed signals with one of frequency components of the read signals attenuated. The frequency component to be attenuated is preferably determined by the lengths of the marks. The optical disc drive preferably further executes the steps of: detecting a phase difference between the processed signals; generating a tracking error signal, representing a positional relationship between a focal point of the light beam on the optical disc and a target one of the tracks, based on the phase difference; generating a control signal based on the tracking error signal: and controlling the focal point of the light beam across the tracks on the optical disc in accordance with the control signal.

A chip circuit according to another preferred embodiment of the present invention is preferably used in an optical disc drive. The optical disc drive preferably includes an optical system for focusing a light beam on an optical disc that includes tracks on which a plurality of marks are formed, and a photodetector, which includes multiple areas to receive the light beam that has been reflected from the optical disc and which generates multiple read signals representing quantities of light received at the areas. The optical disc drive preferably controls a focal point of the light beam across the tracks on the optical disc in accordance with a control signal. The chip circuit preferably includes a filter, a phase difference detecting section, a signal generating section, and a control section. The filter preferably receives the read signals and preferably outputs multiple processed signals with one of frequency components of the read signals attenuated. The frequency component to be attenuated is preferably determined by the lengths of the marks. The phase difference detecting section preferably detects a phase difference between the processed signals. The signal generating section preferably generates a tracking error signal, representing a positional relationship between the focal point of the light beam on the optical disc and a target one of the tracks, based on the phase difference. The control section preferably generates the control signal based on the tracking error signal.

In an optical disc drive according to any of various preferred embodiments of the present invention, the filter preferably attenuates one of multiple frequency components according to the lengths of marks. Accordingly, if a frequency component with small amplitude, which often results in detection errors, is attenuated, for example, a phase difference TE signal can be generated based on frequency components with large amplitudes. Thus, even when loaded with a high-density optical disc, the optical disc drive can still obtain a TE signal of quality and can carry out a tracking control operation accurately enough to perform read and write operations with significantly increased reliability.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1A is a perspective view schematically illustrating a configuration for an optical disc 20.

FIG. 1B is a plan view schematically illustrating tracks 25 that are provided on the optical disc 20.

FIG. 2 is a block diagram showing a configuration for an optical disc drive 100 according to a preferred embodiment of the present invention.

FIG. 3 is a flowchart showing how the optical disc drive 100 carries out a tracking control operation.

FIG. 4 is a graph showing a frequency characteristic of read signals.

FIG. 5 is a graph showing a frequency characteristic of the filters 118a and 118b shown in FIG. 2.

FIG. 6 is a graph showing another frequency characteristic of the read signals.

FIG. 7 is a graph showing another frequency characteristic of the filters 118a and 118b shown in FIG. 2.

FIG. 8 shows the waveforms of respective signals obtained in the optical disc drive 100.

FIG. 9 shows the waveforms of respective output signals in a situation where there is no difference between the slice levels and in a situation where there is a slight difference Δv between the slice levels.

FIG. 10 is a block diagram showing a configuration for a conventional optical disc drive 500.

FIG. 11 shows the waveforms of sum signals A+C and B+D, digital signals a1 and a2, a phase lead signal b1 and a phase lag signal b2.

FIG. 12 shows the waveforms of respective output signals in a situation where there is no difference between the slice levels and in a situation where there is a slight difference Δv between the slice levels.

### DETAILED DESCRIPTION OF PREFERRED EMBODIMENTS

Hereinafter, preferred embodiments of the present invention will be described with reference to the accompanying drawings.

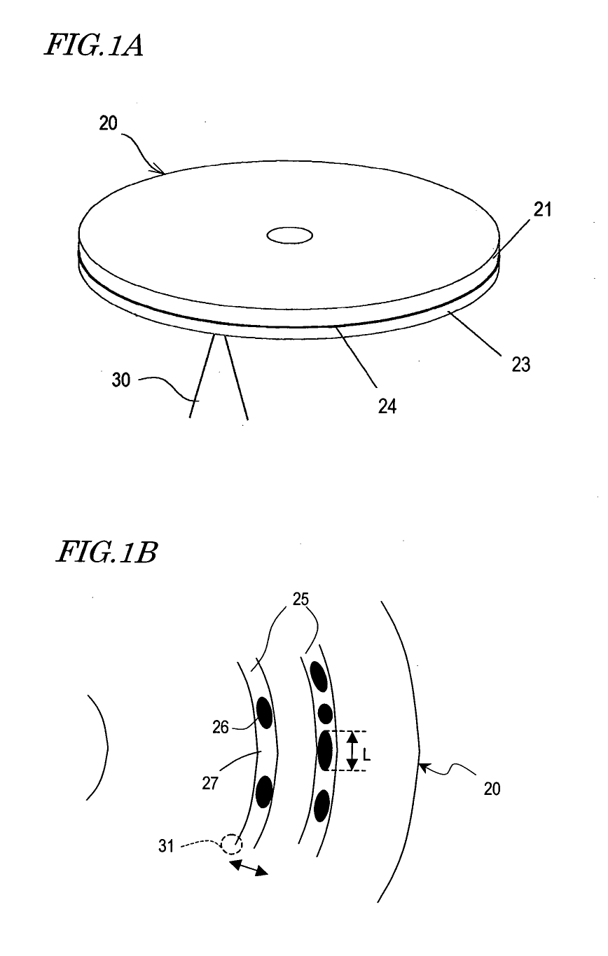

Before an optical disc drive according to a specific preferred embodiment of the present invention is described, an optical disc to be loaded into the optical disc drive will be described. FIG. 1A illustrates a configuration for an optical disc 20. The optical disc 20 may be a rewritable, write-once or read-only Blu-ray disc (BD), for example, and preferably includes a substrate 21, a protective layer 23 and a data storage layer 24. As shown in FIG. 1A, the protective layer 23, data storage layer 24 and substrate 21 are stacked in this order such that an incoming light beam 30 reaches the protective layer 23 first. The substrate 21 preferably has a thickness of about 1 mm and preferably supports the data storage layer 24 thereon. The data storage layer 24 preferably stores data that has been written on the optical disc 20 and may be made of either a phase-change material for a rewritable disc or an organic dye for a write-once disc. The protective layer 23 is preferably a transparent medium with a thickness of about 0.1 mm and preferably transmits the light beam 30 while protecting the data storage layer 24 from scratches, dirt, and so on. FIG. 1A illustrates a state where the optical disc 20 is being irradiated with the light beam 30 just for reference purposes.

At least one track 25 is provided on the optical disc 20. The optical disc 20 to be loaded into an optical disc drive according to any preferred embodiment of the present invention herein includes multiple tracks 25 as shown in FIG. 1B. These tracks 25 preferably have a track pitch (or track width) of about 0.32 μm, for example. On each of these tracks 25, marks 26 and spaces 27 are alternately arranged. The optical disc drive according to any of various preferred embodiments of the present invention to be described later controls the focal point (or beam spot) 31 of the light beam 30 across the tracks 25 (i.e. radial direction) such that the focal point 31 is located right on a target one of the tracks 25 (e.g., such that the beam spot is located on the centerline of the track 25). Such a control operation is called a “tracking control”n. By performing this tracking control operation, the optical disc drive 100 can read or write data from/on the target track.

It should be noted that the length L of each mark 26 is measured herein along the track 25 as shown in FIG. 1B. The minimum length Lmin of marks is uniquely defined by the maximum storage capacity of a given optical disc or by the modulation method adopted for the disc in compliance with its standards. For example, a BD with a storage capacity of 23.3 gigabytes has a minimum mark length Lmin of about 0.16 μm and a DVD has a minimum mark length Lmin of about 0.4 μm.

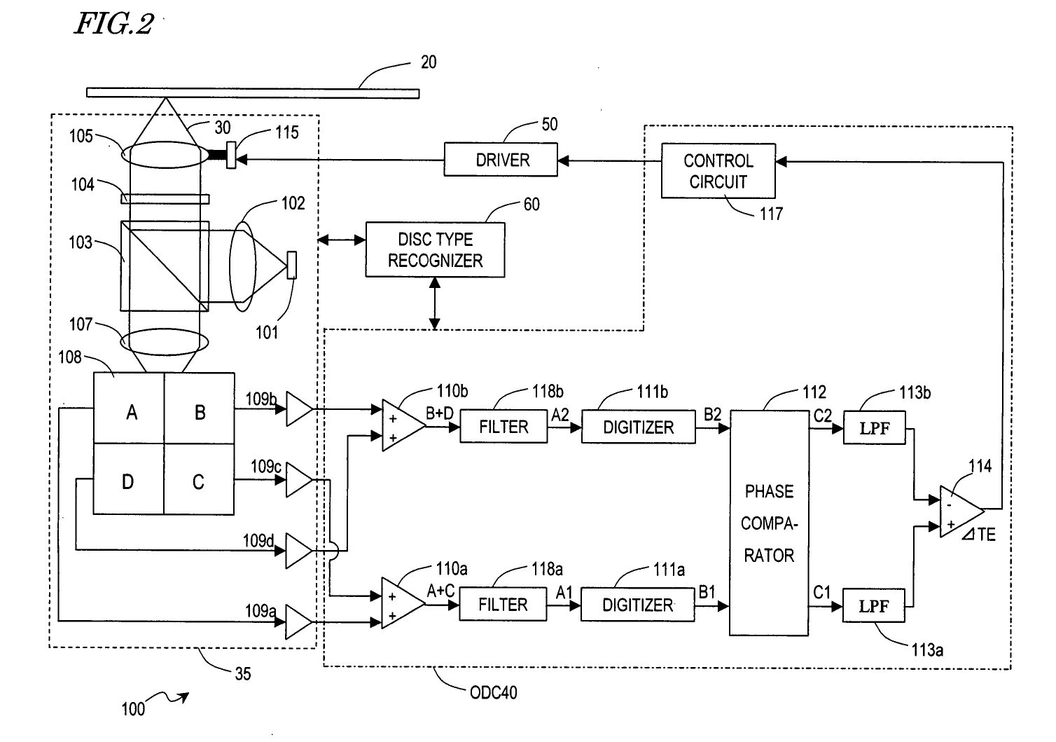

FIG. 2 shows a configuration for an optical disc drive 100 according to a preferred embodiment of the present invention. As shown in FIG. 2, the optical disc drive 100 preferably includes an optical head 35, an optical disc controller (ODC) 40, a driver 50 and a disc type recognizer 60. Although not shown in FIG. 2, the optical disc drive 100 further includes a disc motor for rotating the optical disc 20 thereon. By controlling the rotational velocity of the disc motor, the optical disc drive 100 preferably keeps the linear velocity of the target track, from/on which data is being read or written, constant. The optical disc 20 never belongs to the optical disc drive 100 but is also shown in FIG. 2 for convenience sake.

Hereinafter, the respective components of the optical disc drive 100 will be described in detail. As shown in FIG. 2, the optical head 35 preferably includes a light source 101, a collimator lens 102, a polarization beam splitter 103, a quarter wavelength plate 104, an objective lens 105, a convergent lens 107, a photodetector 108, pre-amplifiers 109a, 109b, 109c and 109d and a tracking actuator 115. In the following description, the pre-amplifiers 109a through 109d will be regarded as belonging to the optical head 35. Alternatively, the pre-amplifiers 109a through 109d may also be provided outside of the optical head 35.

The light source 101 of this optical head 35 may be a semiconductor laser diode to produce a violet laser beam (or light beam) with a wavelength of about 405 nm, for example, and preferably emits the light beam toward the data storage layer 24 of the optical disc 20. The collimator lens 102 preferably transforms the divergent light, emitted from the light source 101, into a parallel light beam. The polarization beam splitter 103 is an optical element for totally reflecting the linearly polarized light that has been emitted from the light source 101 and totally transmitting linearly polarized light that has come perpendicularly to the former linearly polarized light. The quarter wavelength plate 104 is an optical element for transforming the light being transmitted from a circularly polarized light ray into a linearly polarized light ray, or vice versa. The objective lens 105 is provided to focus the light beam onto the data storage layer of the optical disc 20. The convergent lens 107 is provided to converge the light beam, transmitted through the polarization beam splitter 103, onto the photodetector 108. The photodetector 108 preferably includes four divided detecting areas A, B, C and D to convert received light into current signals. The pre-amplifiers 109a, 109b, 109c and 109d are electric elements for converting the current signals, which have been output from the four divided detecting areas A, B, C and D of the photodetector 108, respectively, into voltage signals. The tracking actuator 115 is provided to move the objective lens 105 in the radial direction of the optical disc 20.

Next, the ODC 40 will be described. As shown in FIG. 2, the ODC 40 preferably includes adders 110a and 110b, filters 118a and 118b, digitizers 111a and 111b, a phase comparator 112, low pass filters (LPFs) 113a and 113b, a subtractor 114 and a control circuit 117, each of which is implemented as an electric circuit.

In the ODC 40, the adder 1100a adds together the output signals of the pre-amplifiers 109a and 109c and outputs the resultant sum signal A+C, while the adder 110b adds together the output signals of the pre-amplifiers 109b and 109d and outputs the resultant sum signal B+D. Next, these sum signals A+C and B+D are selectively passed through the filters 118a and 118b and output as signals A1 and A2, respectively. Subsequently, the output signals A1 and A2 of the filters 118a and 118b are converted into digital signals B1 and B2 by the digitizers 111a and 111b, respectively. On receiving the output digital signals B1 and B2 of the digitizers 111a and 111b, the phase comparator 112 compares these signals B1 and B2 with each other, thereby outputting pulse signals C1 and C2, of which the time widths represent the phase leads and phase lags at the edges. Thereafter, the LPFs 113a and 113b respectively smooth out the output pulse signals C1 and C2 of the phase comparator 112. Then, the subtractor 114 calculates and outputs the difference ΔTE between the output smoothed signals of the LPFs 113a and 113b. Finally, in response to the output signal of the subtractor 114, the control circuit 117 outputs a tracking control signal.

The filters 118a and 118b receive the read signals A+C and B+D from the adders 110a and 110b, respectively, and attenuate one of multiple frequency components of the read signals, which is determined by the lengths L of the marks 26 on the optical disc 20, thereby outputting the processed signals A1 and A2, respectively. The filters 118a and 118b may have frequency characteristics such as those shown in FIGS. 5 and 7 as will be described in further detail later.

In response to the tracking control signal supplied from the control circuit 117, the driver 50 outputs a tracking actuator drive signal to the tracking actuator 115.

The disc type recognizer 60 recognizes disc types of the optical disc 20 that has been loaded into this optical disc drive 100, thereby outputting a decision signal representing the result of the type recognition. As used herein, the “disc types” are classified according to not only their physical structures into CDs, DVDs, BDs and so on but also their functions into rewritable ones, write-once ones and read-only ones. For example, the disc type recognizer 60 may recognize the type of the given optical disc 20 by the quantity of spherical aberration generated in the optical disc 20.

Optionally, the disc type recognizer 60 may be provided for the ODC 40. Also, the adders 110a and 110b may be included in the optical head 35.

As will be described in detail later, the optical disc drive 100 preferably detects a tracking error by using a phase difference detecting section and a tracking error signal generating section. In this preferred embodiment, the tracking error signal generating section is made up of the subtractor 114 and the LPFs 113a and 113b. The “phase difference detecting section” is comprised of the adders 110a and 110b, digitizers 111a and 111b and phase comparator 112. That is to say, this optical disc drive 100 includes the tracking error signal generating section, phase difference detecting section, optical head 35 (including the photodetector 108), filters 118a and 118b and tracking control section. The tracking control section includes the tracking actuator 115, driver 50 and control circuit 117.

The optical disc drive 100 of this preferred embodiment of the present invention preferably detects a phase difference by reference to the edges of the digital signals. However, the present invention is in no way limited to this specific preferred embodiment. Thus, the optical disc drive 100 may also detect the phase difference by any other method.

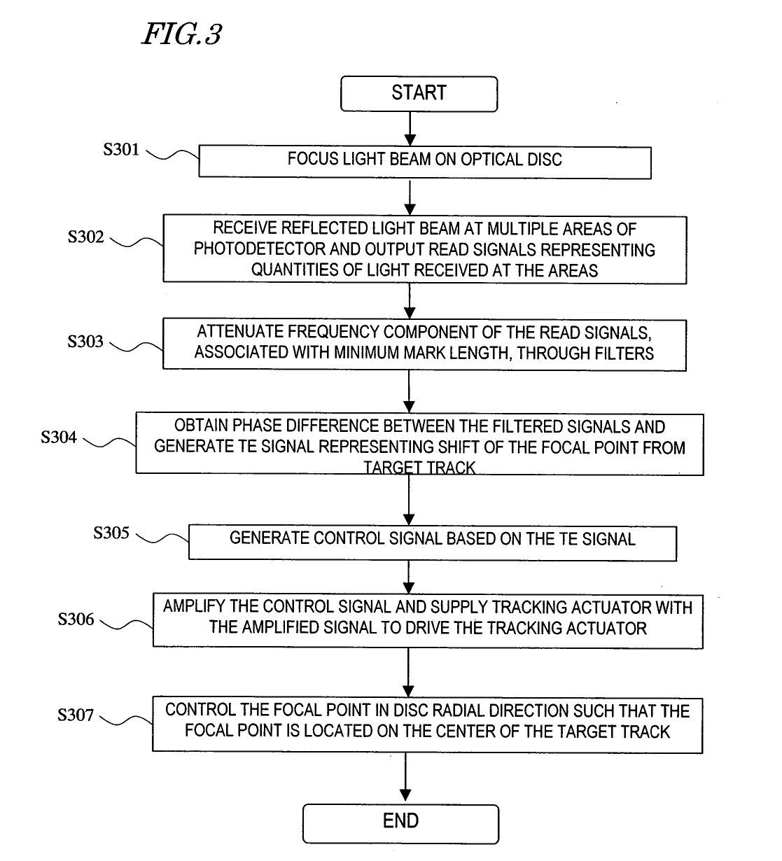

Hereinafter, it will be described with reference to FIGS. 3 through 8 exactly how the optical disc drive 100 of this preferred embodiment carries out the tracking control operation. FIG. 3 is a flowchart showing the procedure of the tracking control operation to be done by the optical disc drive 100. First, in Step S301, the light source 101 of the optical disc drive 100 emits a light beam 30 toward the optical disc 20. Next, in Step S302, the photodetector 108 receives the light beam, reflected from the optical disc 20, at the areas A, B, C and D, thereby outputting read signals representing the quantities of light received at the respective areas. Thereafter, the adder 110a adds together the output signals of the pre-amplifiers 109a and 109c, thereby outputting the resultant sum signal A+C. Meanwhile, the adder 110b adds together the output signals of the preamplifiers 109b and 109d, thereby outputting the resultant sum signal B+D. It should be noted that these processing steps S301 and S302 are no different from those of the tracking control operation to be carried out by the conventional optical disc drive 500.

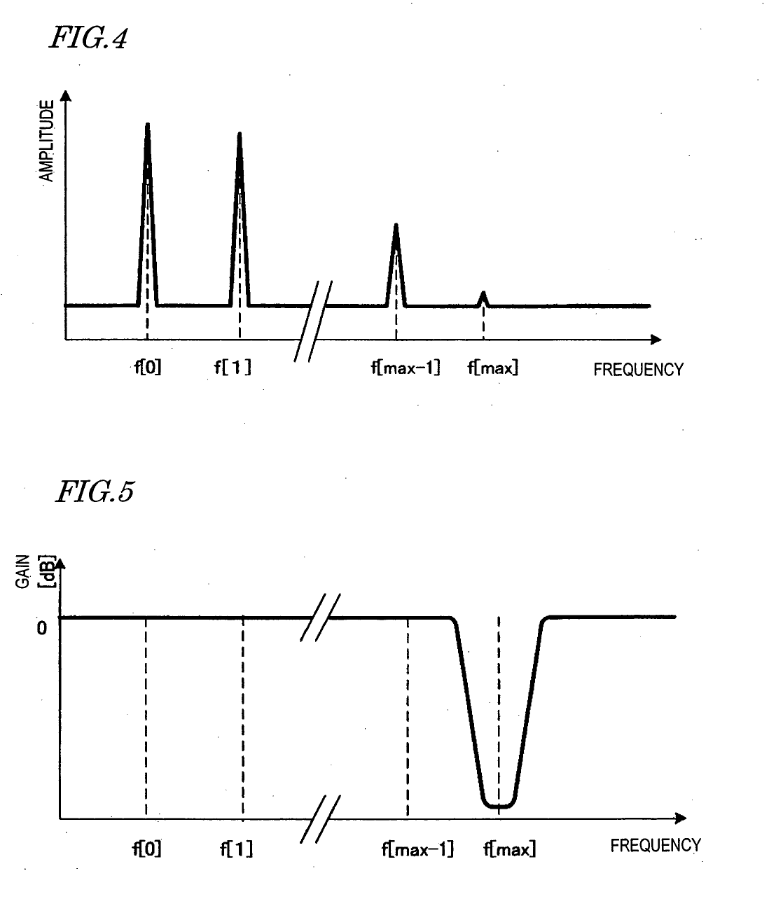

FIG. 4 shows an exemplary frequency characteristic of the read signals. In FIG. 4, the abscissa represents the frequency and the ordinate represents the amplitude. On the optical disc 20, the marks 26 have various different lengths. Accordingly, the read signals exhibit such a frequency characteristic that the amplitude thereof reaches its peak values at frequencies f[0], f[1], . . . , f[max-1] and f[max] corresponding to the frequencies at which the marks are read. Specifically, the lowest frequency f[0] corresponds to a signal frequency at which a mark with the maximum length Lmax is read. On the other hand, the highest frequency fx[max] corresponds to a signal frequency at which a mark with the minimum length Lmin is read. It can be easily seen from FIG. 4 that the amplitude of the signal with the highest frequency f[max] is much smaller than that of a signal with any other frequency.

In a BD with a storage capacity of about 23.3 gigabytes, for example, when the tracks 25 thereof have a linear velocity of about 5.28 m/s, the highest frequency f[max] corresponding to the minimum mark length of about 0.16 Am is about 16.5 MHz. In this preferred embodiment, however, the optical disc 20 is supposed to be rotated such that the tracks 25 have a constant linear velocity. Thus, the frequency f[max] is a fixed value, which can be calculated in advance. It should be noted that the linear velocity is normally changeable with the rotation method of the optical disc and/or the read/write rate (such as 2× or 4× read/write rate). Accordingly, the frequencies (including the highest frequency f[max]) corresponding to the respective mark lengths are usually changeable with the rotational velocity and the mark length.

Referring back to FIG. 3, in the next step S303, the filters 118a and 118b respectively attenuate the frequency component of the read signals A+C and B+D, which corresponds to the minimum mark length Lmin, thereby obtaining filter output signals A1 and A2.

This processing step S303 will be described in further detail with reference to FIG. 5, which shows a frequency characteristic of the filters 118a and 118b. In FIG. 5, the abscissa represents the frequency and the ordinate represents the gain. As shown in FIG. 5, each of the filters 118a and 118b has a characteristic of attenuating the frequency f[max]. The frequency f[max] is determined by the linear velocity of a target track when the beam spot passes a mark on the track and by the minimum mark length, and is the same as the frequency f[max] of the signal with the small amplitude as shown in FIG. 4. The linear velocity is changeable as described above. Accordingly, by changing the settings, for example, the controller of the optical disc drive 100 or ODC 40 can change the frequency characteristic (i.e., the cutoff frequency f[max]) of the filters dynamically. Specifically, the frequency f is given by f=v/(2L), where v is the linear velocity and L is the mark length. In the preferred embodiment shown in FIG. 5, the filters 118a and 118b have a gain of 0 dB up to the frequency f[max-1] so as to pass the input signal as it is. Alternatively, the filters 118a and 118b may also have their bandpass characteristic modified so as to pass signal components having frequencies f[0] through f[max] and to filter out signal components of which the frequencies are lower than f[0] or higher than f[max].

By getting the read signals A+C and B+D having the frequency characteristic shown in FIG. 4 passed through the filters 118a and 118b having the frequency characteristic shown in FIG. 5, the amplitude of the read signals at the frequency f[max] is either attenuated or reduced to zero. As a result, the signals A1 and A2 having frequencies f[0] through f[max-1] can be obtained.

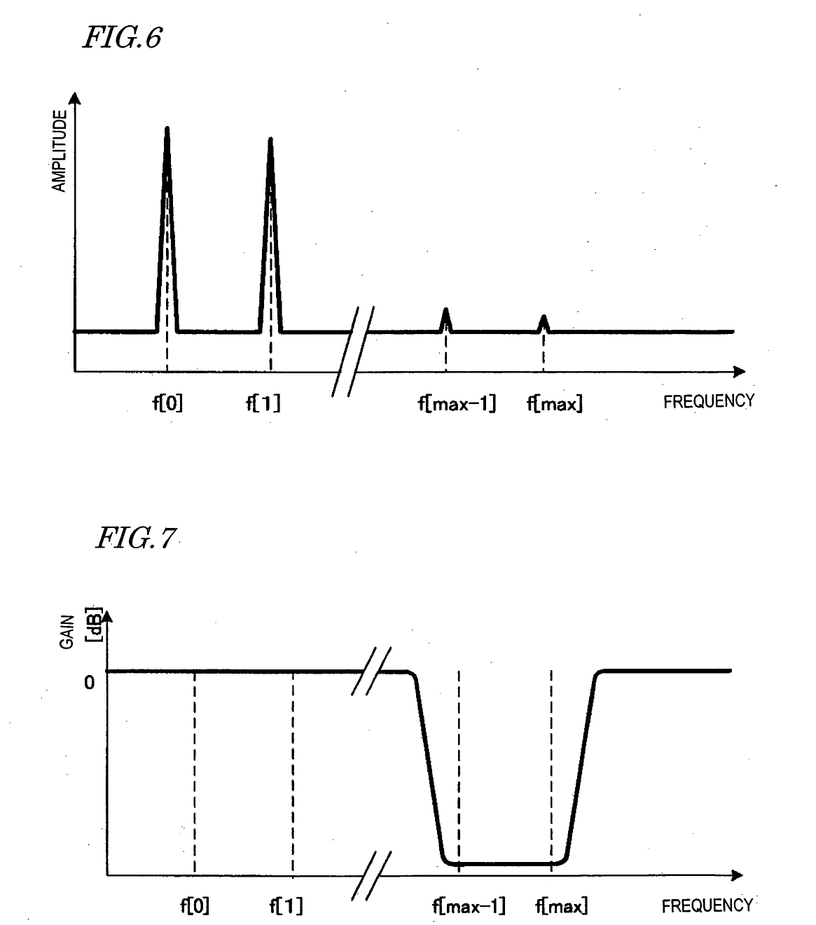

It should be noted that if the amplitude of the read signals at any frequency other than the frequency f[max] (e.g., at f[max-1] in the example shown in FIG. 6) is almost as small as that of the read signals at the frequency f[max], then the signal components having the frequencies f[max] and f[max-1] may be filtered out by the filters 118a and 118b having a frequency characteristic such as that shown in FIG. 7. The frequency f[max-1] corresponds to a mark of second shortest length. It is beneficial to remove the signal components having the frequencies f[max] and other(s) in the case amplitudes of the frequencies are as small as that of a noise signal.

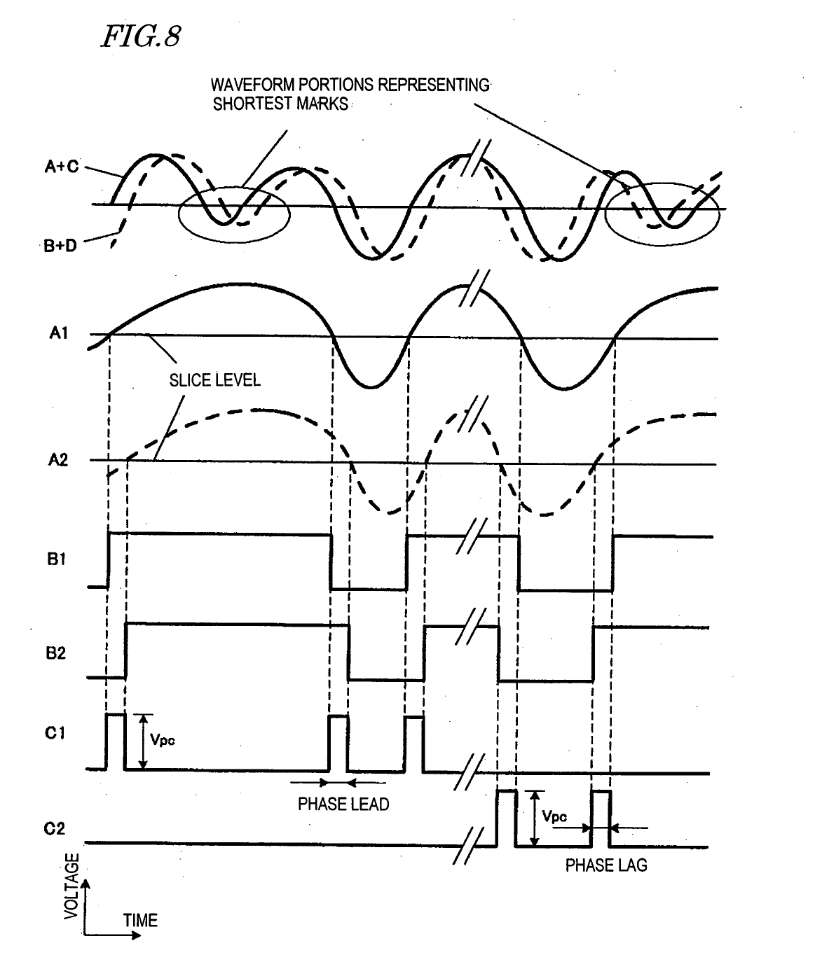

FIG. 8 shows the waveforms of respective signals obtained in the optical disc drive 100. Comparing the waveforms of the sum signals A+C and B+D with those of the filter output signals A1 and A2, it can be seen that the signal components representing the shortest marks (i.e., signal components having the frequency f[max]) have been substantially filtered out.

Referring back to FIG. 3, in the next step S304, a phase difference between the filter output signals A1 and A2 is obtained, thereby generating a TE signal representing a positional relationship between the focal point of the light beam and the target track. This processing step S304 will be described in further detail with reference to FIG. 8. First, the digitizers 111a and 111b convert the filter output signals Al and A2 into digital signals B1 and B2 by reference to the slice level shown in FIG. 8. That is to say, if the filter output signal A1 or A2 is equal to or higher than the slice level, the digitizer 111a or 111b generates a signal B1 or B2 with a high-level voltage. Otherwise, the digitizer 111a or 111b generates a signal B1 or B2 with a low-level voltage.

Subsequently, the phase comparator 112 compares the phases of the digital signals B1 and B2 at the respective edges, thereby generating a pulse signal, of which the pulse width represents the phase lead, as a phase lead signal C1 and a pulse signal, of which the pulse width represents the phase lag, as a phase lag signal C2, respectively. Generating these phase lead and lag signals C1 and C2 is equivalent to obtaining a phase difference between the filter output signals A1 and A2. The phase lead and lag signals C1 and C2 shown in FIG. 8 have pulse amplitude Vpc. Thereafter, the LPFs 113a and 113b smooth out the phase lead and lag signals C1 and C2, respectively, thereby converting them into voltage signals of which the levels represent the pulse widths. Then, the subtractor 114 obtains a difference between these voltage signals, thereby generating a phase difference TE signal ΔTE representing the tracking error of the beam spot. Even if a signal resulting from the shortest mark has almost the same level as noise, the signal component can still be removed. Accordingly, the phase difference TE signal obtained in this manner should be of higher quality than that obtained by the conventional optical disc drive 500.

Next, in Step S305, the control circuit 117 performs a filter operation on the phase difference TE signal to subject the signal to phase compensation and low-frequency compensation, thereby outputting a control signal through its internal D/A converter (not shown). Subsequently, in Step S306, the driver 50 amplifies the control signal, thereby supplying the tracking actuator 115 with a current. Finally, in Step S307, the objective lens 105 is moved in the radial direction of the optical disc 20, thereby controlling the focal point of the light beam in the same direction such that the beam spot is located right on the centerline of the target track.

By performing these processing steps, the optical disc drive 100 can obtain a phase difference TE signal of quality and can carry out a tracking control operation based on the TE signal.

In the tracking control operation described above, even if the slice level changes slightly while the digitizers 111a and 111b are converting the filter output signals into digital signals, the phase difference TE signal is hardly affected.

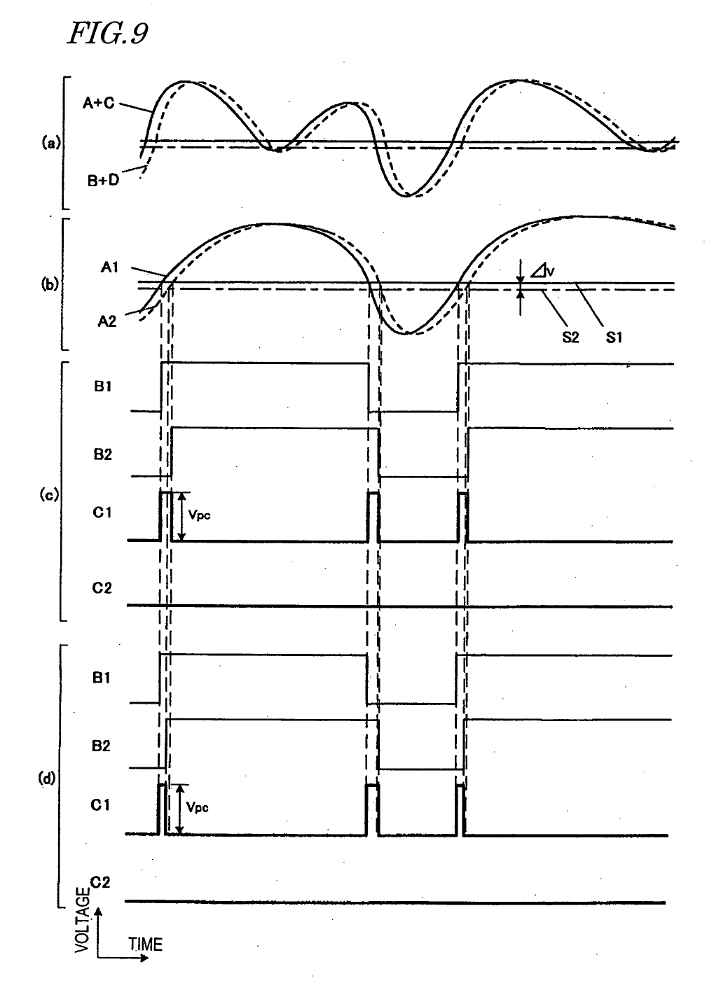

FIG. 9 shows the waveforms of the output signals of the respective circuits in a situation where there is no small difference Δv between the slice levels and a situation where there is a small difference Δv between the slice levels. Specifically, portion (a) of FIG. 9 shows the waveforms of the output signals A+C and B+D of the adders 110a and 110b in a situation where the beam spot has a certain shift with respect to the target track (i.e., in an off-track state). On the other hand, portion (b) of FIG. 9 shows the waveforms of the output signals A1 and A2 of the filters 118a and 118b. As can be seen from this portion (b), the frequency components representing the shortest marks have been attenuated by the filters 118a and 118b. If there is no difference between the slice levels of the digitizers 111a and 111b, then the digitizers 111a and 111b will have the same slice level S1. On the other hand, if there is a small difference Δv between them, then the digitizers 111a and 111b will have their respective slice levels S1 and S2.

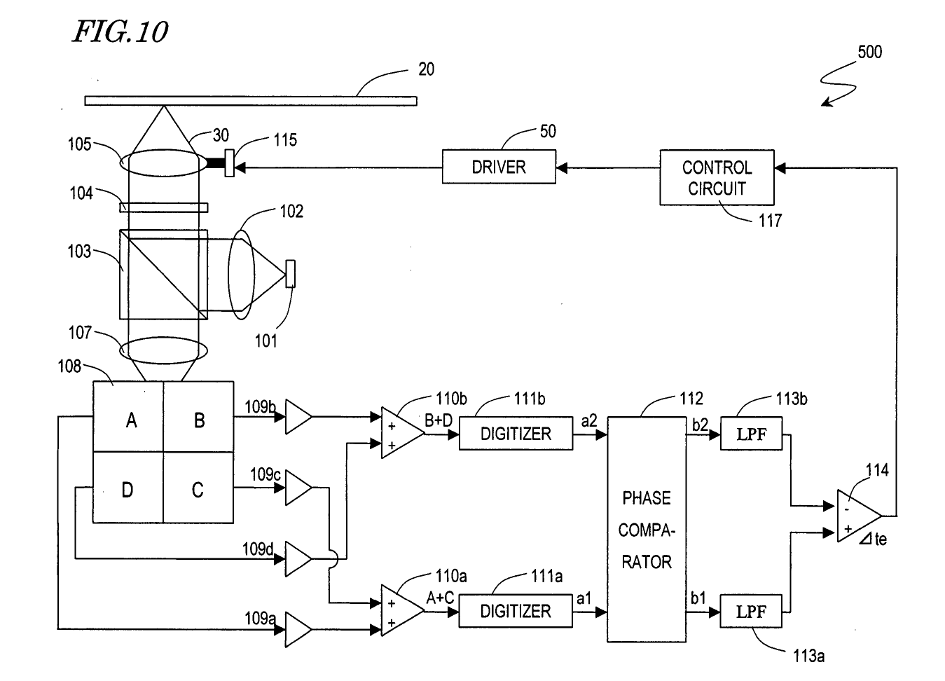

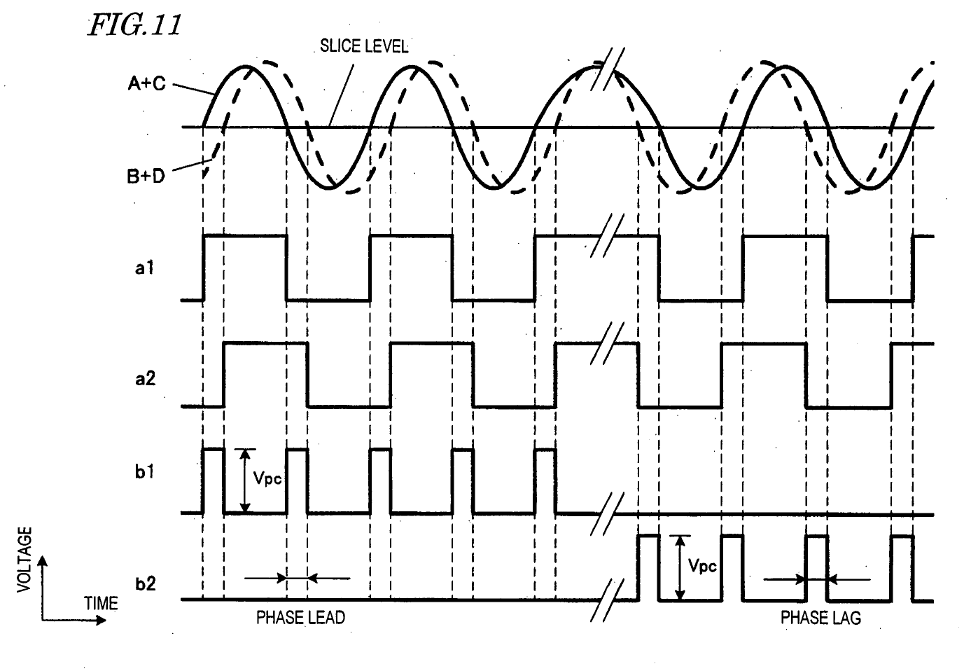

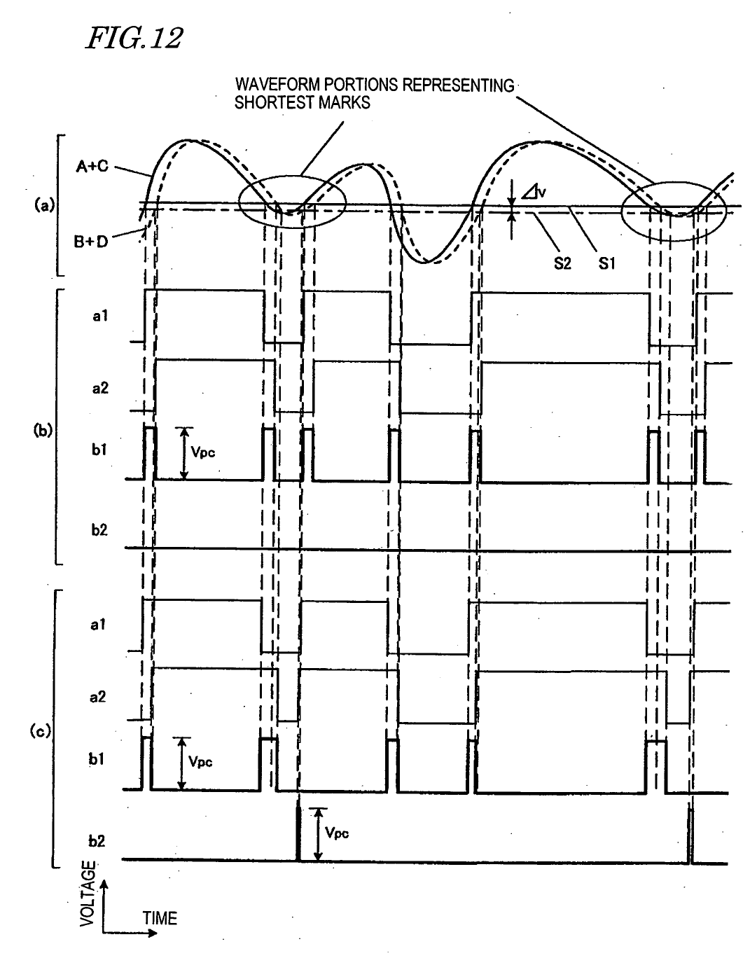

Furthermore, portion (c) of FIG. 9 shows the waveforms of the output signals B1, B2, C1 and C2 in a situation where there is no difference between the slice levels, while portion (d) of FIG. 9 shows the waveforms of the output signals B1, B2, C1 and C2 in a situation where there is a small difference Δv between the slice levels. Comparing the waveforms of the output signals C1 and C2 of portion (c) with those of portion (d), the phase lead signals C1 show a very small difference between their waveforms due to the slight difference Δv in the slice level. As for the phase lag signal C2 on the other hand, there is no difference at all. Thus, this difference is significantly smaller than the difference between the waveforms of the output signals b1 or b2 shown in portions (b) and (a) of FIG. 12 for the conventional optical disc drive 500 of FIG. 10.

Thus, if the phase difference is detected by using only portions of the signals A+C and B+D with large amplitudes, then the detection errors, which might occur due to the slight difference Δv in the slice level, can be minimized. As a result, the optical disc drive 100 can minimize the detection errors of the TE signal due to the variation in the slice level.

The operations of the optical disc drive 100 described above are defined by at least one computer program. A portion of the computer program is stored in a memory (not shown), which is normally built in an optical disc drive, or in a memory for a microcomputer (not shown, either). Such a computer program is executed by a CPU (not shown, either) that controls the overall operation of the optical disc drive.

The ODC 40 may be implemented by at least one semiconductor chip circuit. In that case, the respective components of the ODC 40 may represent respective function blocks of the semiconductor chip circuit. The computer program described above is stored in a memory area of the semiconductor chip circuit such that the microcomputer (not shown) in the ODC 40 can carry out the tracking control in accordance with the computer program. The ODC 40 also has the functions of reading data from the data storage layer and subjecting the data to error correction, decoding and other processes after having performed the tracking control described above.

The computer program may be stored in any of various types of storage media. Examples of preferred storage media include optical storage media such as optical discs, semiconductor storage media such as an SD memory card and an EEPROM, and magnetic recording media such as a flexible disk. Alternatively, the computer program may also be downloaded via a telecommunications line (e.g., through the Internet, for example) and installed in the optical disc drive 100.

In the preferred embodiments described above, the optical disc 20 is supposed to be a BD. However, similar effects are also achievable on a DVD through the same processing steps. Recently, DVD drives have increased their rotational velocities tremendously, thus requiring more and more accurate tracking control techniques. Under the circumstances such as these, the processing according to preferred embodiments of the present invention should be very effectively applicable for use in DVDS, too. It should be noted that if the optical disc drive 100 is compatible with both BDs and DVDS, then the disc type recognizer 60 shown in FIG. 2 may recognize the type of the given disc and then switch the frequency characteristics of the filters 118a and 118b according to the type recognized. For example, a frequency characteristic for BDs may be defined so as to attenuate the frequency f[max] and another frequency characteristic for DVDs may be defined so as to pass all frequencies without attenuating them at all. And these two frequency characteristics for BDs and DVDs may be switched in response to the type recognition signal supplied from the disc type recognizer 60. When the frequency characteristic for DVDs is adopted, the signals that have passed through the filters may be amplified by equalizers (not shown).

In the preferred embodiments described above, the output signals of the pre-amplifiers 109a through 109d are processed by analog circuits. However, similar effects are also achievable even by using digital circuits. In that case, the output signals of the pre-amplifiers 109a through 109d may be converted by an A/D converter into digital signals and then the processing steps described above may be carried out on the digital signals sequentially.

Also, in the preferred embodiment described above, the optical disc drive 100 attenuates the frequency f[max] of the read signals corresponding to the shortest marks. However, this frequency may be determined by any other parameter. For example, the frequency f[max] may be determined by the type or rotational velocity of the given optical disc. Alternatively, f[max] may also be determined by detecting the frequency characteristic of the reflected light.

Various preferred embodiments of the present invention described above realize a highly accurate tracking control operation by generating a tracking error signal of quality. Thus, even in reading or writing data from/on a high-density optical disc, the present invention ensures very high reliability.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An optical disc drive to be loaded with an optical disc that includes tracks on which a plurality of marks are formed, the optical disc drive comprising:
an optical system for focusing a light beam on the optical disc loaded;
a photodetector, which includes multiple areas to receive the light beam that has been reflected from the optical disc and which generates multiple read signals representing quantities of light received at the areas;
a filter, which receives the read signals and which outputs multiple processed signals with one of frequency components of the read signals attenuated, the frequency component to be attenuated being determined by the lengths of the marks;
a phase difference detecting section for detecting a phase difference between the processed signals;
a signal generating section for generating a tracking error signal, representing a positional relationship between a focal point of the light beam on the optical disc and a target one of the tracks, based on the phase difference; and
a control section for generating a control signal based on the tracking error signal,
wherein in accordance with the control signal, the optical disc drive controls the focal point of the light beam across the tracks on the optical disc.

2. The optical disc drive of claim 1, wherein the optical system includes:
a light source, which emits the light beam;
a lens, which focuses the light beam on the optical disc; and
an actuator, which adjusts a position of the lens, and
wherein in response to the control signal, the optical disc drive drives the actuator to adjust the position of the lens such that the focal point of the light beam is located on the center of the target track.

3. The optical disc drive according to claim 2, wherein the filter removes the frequency component.

4. The optical disc drive according to claim 2, wherein the filter removes a frequency component of a particular frequency that is determined by the minimum length of the marks.

5. The optical disc drive according to claim 4, wherein the filter removes frequency components of which the frequencies are equal to or higher than the particular frequency.

6. The optical disc drive according to claim 4, wherein the filter further removes a frequency component of a frequency that corresponds to a mark of a second shortest length.

7. The optical disc drive according to claim 1, wherein the optical disc drive determines the frequency by a linear velocity of the track and the length of the mark at the focal point of the light beam, and
wherein the filter attenuates the frequency component of the determined frequency.

8. A tracking control method comprising steps of:
focusing a light beam on an optical disc that includes tracks on which a plurality of marks are formed;
receiving the light beam, reflected from the optical disc, at multiple areas;
generating multiple read signals representing quantities of light received at the areas;
receiving the read signals and outputting multiple processed signals with one of frequency components of the read signals attenuated, the frequency component to be attenuated being determined by the lengths of the marks;
detecting a phase difference between the processed signals;
generating a tracking error signal, representing a positional relationship between a focal point of the light beam on the optical disc and a target one of the tracks, based on the phase difference;
generating a control signal based on the tracking error signal: and
controlling the focal point of the light beam across the tracks on the optical disc in accordance with the control signal.

9. A computer program product for use with an optical disc drive for tracking control purposes, the optical disc drive to be loaded with an optical disc that includes tracks on which a plurality of marks are formed,
wherein the computer program product causes the optical disc drive to perform steps of:
focusing a light beam on the optical disc loaded;
receiving the light beam, reflected from the optical disc, at multiple areas;
generating multiple read signals representing quantities of light received at the areas;
receiving the read signals and outputting multiple processed signals with one of frequency components of the read signals attenuated, the frequency component to be attenuated being determined by the lengths of the marks;
detecting a phase difference between the processed signals;
generating a tracking error signal, representing a positional relationship between a focal point of the light beam on the optical disc and a target one of the tracks, based on the phase difference;
generating a control signal based on the tracking error signal; and
controlling the focal point of the light beam across the tracks on the optical disc in accordance with the control signal.

10. A chip circuit for use in an optical disc drive, the optical disc drive having:
an optical system for focusing a light beam on an optical disc that includes tracks on which a plurality of marks are formed; and
a photodetector, which includes multiple areas to receive the light beam that has been reflected from the optical disc and which generates multiple read signals representing quantities of light received at the areas,
the optical disc drive controlling a focal point of the light beam across the tracks on the optical disc in accordance with a control signal,
wherein the chip circuit comprises:
a filter, which receives the read signals and which outputs multiple processed signals with one of frequency components of the read signals attenuated, the frequency component to be attenuated being determined by the lengths of the marks;
a phase difference detecting section for detecting a phase difference between the processed signals;
a signal generating section for generating a tracking error signal, representing a positional relationship between the focal point of the light beam on the optical disc and a target one of the tracks, based on the phase difference; and
a control section for generating the control signal based on the tracking error signal.
